(19) United States
(12) Patent Application Publication
(10) Pub. No.: US 2008/0117724 A1
(43) Pub. Date: May 22, 2008

(54) OPTICAL PICKUP AND OPTICAL DISC DEVICE EMPLOYING THE SAME

(75) Inventor: Yoshiki OKAMOTO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/874,464

(22) Filed: Oct. 18, 2007

(30) Foreign Application Priority Data
Nov. 20, 2006 (JP) 2006-313373

(51) Int. Cl. G11B 11/00; G11B 7/00

(52) U.S. Cl. 369/13.3; 369/44.24

(57) ABSTRACT

An optical pickup includes: a light source emitting a light beam; an objective lens condensing the light beam emitted from the light source on a recording layer of an optical disc; a photodetector including a photoreception portion receiving the returned light from the optical disc; an optical-path separating unit separating the optical path of the returned light reflected at the optical disc from the optical path of the light beam emitted from the light source; an astigmatism generating unit generating astigmatism regarding a light beam to pass through, forming an image in a first direction at a first position in the optical axis direction, and also forming an image in a second direction generally orthogonal to the first direction at a second position in the optical axis direction; and a polarization-direction adjusting unit adjusting the polarization direction of a light beam to pass through for each region.

### CROSS REFERENCES TO RELATED APPLICATIONS

The present invention contains subject matter related to Japanese Patent Application JP 2006-313373 filed in the Japanese Patent Office on Nov. 20, 2006, the entire contents of which are incorporated herein by reference.

### BACKGROUND OF THE INVENTION

1. Field of the Invention

The present invention relates to an optical pickup employed for recording an information signal in an optical disc, and playing an information signal recorded onto an optical disc, and an optical disc device employing the same.

2. Description of the Related Art

Heretofore, there has been provided an optical disc device for recording an information signal in an optical disc such as CD (Compact Disc), DVD (Digital Versatile Disc) employed as a recording medium of an information signal, or for playing an information signal recorded in an optical disc, and this optical disc device has been provided with an optical pickup, which is moved in the radial direction of an optical disc, for irradiating a light beam as to this optical disc.

The optical pickup generally includes a light source, a beam splitter, an objective lens, a photoreceptor, and so forth, the light beam emitted from the light source transmits the beam splitter, and is condensed by the objective lens to form a light beam spot on a recording layer of an optical disc. Also, the light beam condensed on the recording layer of the optical disc is reflected and entered into the beam splitter again, whereby the optical path is changed by the beam splitter, and enters the photoreceptor.

### SUMMARY OF THE INVENTION

Optical discs include a single-layer type including a single recording layer, and a multi-layer type in which multiple layers are provided. With this multi-layer type optical disc, for example, in the event of a light beam condensing on a single recording layer, the light beam is also reflected at another recording layer adjacent to this single recording layer.

Also, with a single-layer type optical disc as well, in the event of a light beam condensing on a recording layer, the light beam is also reflected at the surface of the optical disc (hereafter, the recording layers other than this and the surface will also be referred to as “other recording layers or the like”).

Thus, there is a possibility that not only a light beam reflected at a recording layer on which the light beam condenses to perform recording or playback, but also light beams reflected at other recording layers or the like may enter the photoreceptor as stray light.

Such stray light is a factor in causing a trouble such as deterioration of RF (Radio Frequency) signal quality, offset of a servo signal, or the like, and also is a factor in causing interference of a light beam reflected at each layer of an optical disc. That is to say, the light beam reflected at a recording layer where recording or playback of an information signal is performed is overlapped with the light beam reflected at another recording layer or the like, and causes inference on the photoreception portion of a photoreceptor, so unwanted interference streaks occur within the beam spot on the photo acceptance portion, and as a result thereof, a noise component occurs within the detected signal.

Thus, in the event of subjecting an optical disc or the like including multiple recording layers to recording/playback of an information signal, not only the returned light (returning light) from a focus recording layer where recording/playback is performed but also the returned light from the other recording layers which exist before and after the focus recording layer exist at the photoreception portion, which interfere with each other. This interference has caused a problem in that a noise component occurs within a signal detected at a photodetector.

There has been recognized a need for an optical pickup and an optical disc device, whereby interference caused by stray light from other recording layers or the like entering returned light from a recording layer where recording or playback of an optical disc is performed to a photoreception portion can be prevented, and consequently noise component can be prevented from occurring within a signal detected with the returned light.

An optical pickup according to an embodiment of the present invention configured to subject an optical disc having a single or plurality of recording layers in the incidence direction of a light beam to recording and/or playback of information, includes: a light source configured to emit a light beam having a predetermined wavelength; an objective lens configured to condense the light beam emitted from the light source on a recording layer of an optical disc; a photodetector including a photoreception portion configured to receive the returned light from the optical disc; an optical path separating unit, which is disposed between the light source and the objective lens, configured to separate the optical path of the returned light reflected at the optical disc from the optical path of the light beam emitted from the light source; an astigmatism generating unit, which is provided between the optical path separating unit and the photoreception portion, configured to generate astigmatism regarding a light beam to pass through, to form an image in a first direction at a first position in the optical axis direction, and also to form an image in a second direction generally orthogonal to the first direction at a second position in the optical axis direction which is a position different from the first position; and an polarization direction adjusting unit, which includes four regions obtained by being divided into two with each of the parting lines formed in the first and second directions, configured to adjust the polarization direction of a light beam to pass through for each region; wherein the polarization direction adjusting unit adjusts a first polarization direction of a light beam to be emitted passing through a region facing in one diagonal direction, and a second polarization direction of a light beam to be emitted passing through a region facing in the other diagonal direction so as to be mutually orthogonal.

Also, an optical disc device according to an embodiment of the present invention includes: an optical pickup configured to subject an optical disc having a single or plurality of recording layers in the incidence direction of a light beam to recording and/or playback of information; and a rotational driving unit configured to rotate the optical disc, and an optical pickup such as described above is employed as an optical pickup employed for this optical disc device.

With an embodiment of the present invention, an astigmatism generating unit generates astigmatism regarding a light beam to pass through, form an image in a first direction at a first position, and also form an image in a second direction at a second position, and a polarization direction adjusting unit, which includes four regions obtained by being divided into two with each of the parting lines formed in the first and second directions, adjust the polarization direction of a light beam to be emitted passing through a region facing in one diagonal direction, and the polarization direction of a light beam to be emitted passing through a region facing in the other diagonal direction so as to be mutually orthogonal, thereby realizing to prevent interference caused by stray light from another recording layer or the like entering returned light from a recording layer where recording or playback of an optical disc is performed to a photoreception portion, and to prevent a noise component from occurring within a signal detected with the returned light.

### BRIEF DESCRIPTION OF THE DRAWINGS

FIG. 1 is a perspective view illustrating the overview of an optical disc device to which an embodiment of the present invention is applied;

FIG. 2 is a cross-sectional view illustrating the overview of an optical disc employed for an optical disc device or optical pickup to which an embodiment of the present invention is applied;

FIG. 3 is an optical path diagram describing the optical system of an optical pickup to which an embodiment of the present invention is applied;

FIG. 4 is a diagram illustrating a front focal line and a back focal line of which the image is formed by a condenser lens or cylindrical lens making up the optical pickup;

FIG. 5 is a plan view illustrating a polarization direction adjusting unit making up the optical pickup;

FIGS. 6A through 6B are diagrams describing the detection of a focus error signal in the case of sharing the cylindrical lens making up the optical pickup as an element for generating astigmatism to detect a focus error signal employing an astigmatic method, wherein FIG. 6A is a plan view illustrating a spot shape on a photoreception portion in a state in which an objective lens approaches the optical disc from a perfectly-focused state, FIG. 6B is a plan view illustrating a spot shape on the photoreception portion in a perfectly-focused state, and FIG. 6C is a plan view illustrating a spot shape on the photoreception portion in a state in which the objective lens is separated from the optical disc from a perfectly-focused state;

FIGS. 7A through 7C are diagrams illustrating first through third states of a light beam of which the polarization state was adjusted by the polarization direction adjusting unit of the optical pick to which an embodiment of the present invention is applied, wherein FIG. 7A is a diagram illustrating the polarization state of the light beam in the first state which illustrates a front state from a focal line, FIG. 7B is a diagram illustrating the polarization state of the light beam in the second state which illustrates a state between focal lines, and FIG. 7C is a diagram illustrating the polarization state of the light beam in the third state which illustrates a back state from a focal line;

FIG. 8 is a diagram illustrating a light beam passing through the polarization direction adjusting unit, condenser lens, and cylindrical lens which make up the optical pickup, and entering the photoreception portion of a photodetector, and is a diagram illustrating a state in which the light beams returning from a focus recording layer and other recording layers condense on the photoreception portion;

FIG. 9 is a diagram illustrating each polarization state of states in which the light beams returning from the focus recording layer and other recording layers enter on the photodetector making up the optical pickup;

FIG. 10 is a plan view illustrating another example of the polarization direction adjusting unit making up the optical pickup;

FIG. 11 is a diagram illustrating each polarization state of states in which the light beams returning from the focus recording layer and other recording layers enter on the photodetector in the case of employing the polarization direction adjusting unit shown in FIG. 10;

FIG. 12 is an optical path diagram describing another example of the optical system of the optical pickup to which an embodiment of the present invention is applied;

FIG. 13 is a plan view of a polarizer making up the optical pickup;

FIG. 14 is a diagram illustrating a light beam passing through the polarization direction adjusting unit, condenser lens, and cylindrical lens which make up the optical pickup including the polarizer shown in FIG. 13, and entering the polarizer and photoreception portion, and is a diagram illustrating a state in which the light beams returning from the focus recording layer and other recording layers condense on the photoreception portion; and

FIG. 15 is a plan view illustrating another example of the polarizer making up the optical pickup.

### DESCRIPTION OF THE PREFERRED EMBODIMENTS

Description will be made below regarding an optical disc device employing an optical pickup to which an embodiment of the present invention is applied, with reference to the drawings.

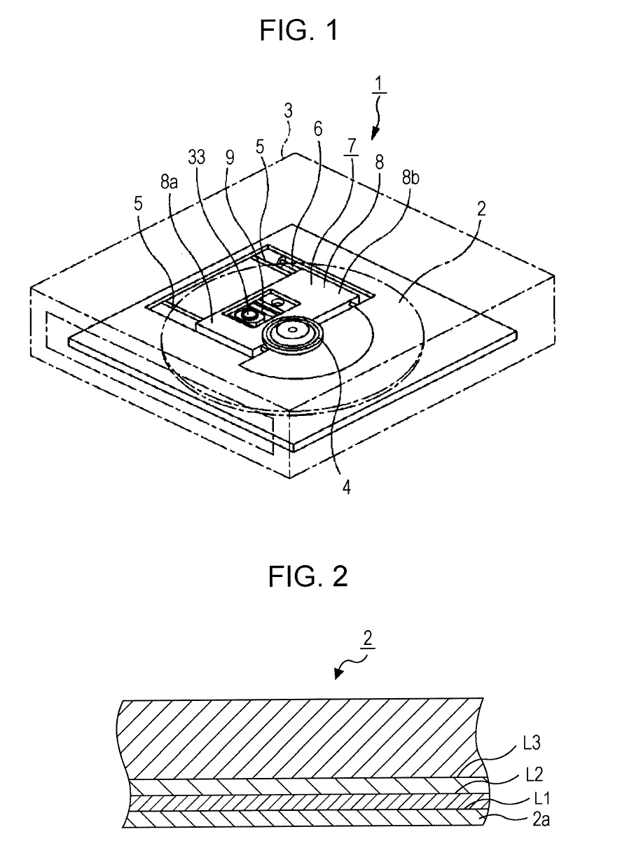

An optical disc device 1 to which an embodiment of the present invention is applied is, as shown in FIG. 1, a recording/playback device for subjecting an optical disc 2 to recording and/or playback of an information signal.

Examples to be employed as the optical disc 2 of which the recording and/or playback is performed at the optical disc device 1 include CD (Compact Disc), DVD (Digital Versatile Disc), CD-R (Recordable) and DVD-R (Recordable) to which information can be added, optical disc such as CD-RW (ReWritable), DVD-RW (ReWritable), DVD+RW (ReWritable), and so forth of which the information is rewritable, and further optical disc employing a semiconductor laser with a short wavelength of 405 nm or so (blue-violet) whereby high density recording can be performed, and a magneto-optic disc.

Description will be made below particularly assuming that an optical disc 2 including three recording layers is employed as an optical disc employed by the optical disc device 1, but the optical disc where recording or playback of an information signal is performed by the optical disc device 1 and an optical pickup is not restricted to this, so any optical disc can be employed as long as the optical disc is configured by a single or multiple recording layers being layered in the incidence direction of a light beam. Specifically, with the optical disc 2, in order from the incident side of a light beam, a cover layer 2a, a recording layer L1, a recording layer L2, and a recording layer L3 are formed. Here, the thickness of the cover layer 2a is formed in 75 μm, the interval between the recording layer L1 and the recording layer L2, and the interval between the recording layer L2 and the recording layer L3 are formed in 25 μm.

The optical disc device 1 is, as shown in FIG. 1, configured of each necessary member and each necessary mechanism being disposed within an outer casing 3, and an unshown disc insertion opening is formed in the outer casing 3.

An unshown chassis is disposed within the outer casing 3, and a disc table 4 is fixed to the motor shaft of a spindle motor attached to the chassis.

A parallel guide shaft 5 is attached to the chassis, and also a lead screw 6 to be rotated by an unshown feed motor is supported with the chassis.

An optical pickup 7 includes, as shown in FIG. 1, a moving base 8, necessary optical parts provided at the moving base, and an objective lens driving device 9 disposed on the moving base 8, bearing portions 8a and 8b provided on both end portions of the moving base 8 are each slidably supported by the guide shaft 5.

An unshown nut member provided at the moving base 8 is screwed with the lead screw 6, and upon the lead screw 6 being rotated by the feed motor, the nut member is delivered in the direction corresponding to the rotational direction of the lead screw 6, and moved in the radial direction of the optical disc 2 where the optical pickup 7 is mounted on the disc table 4.

The optical disc drive 1 thus configured subjects the optical disc 2 to rotational operation using the spindle motor, subjects the lead screw 6 to driving control in accordance with the control signal from a servo circuit, and moves the optical pickup 7 to the position corresponding to a desired recording track of the optical disc 2, thereby subjecting the optical disc 2 to recording/playback of information.

Next, description will be made regarding the above-mentioned optical pickup to which an embodiment of the present invention is applied. The optical pickup 7 subjects the optical disc 2 including a single or multiple recording layers in the incidence direction of a light beam to recording and/or playback of information.

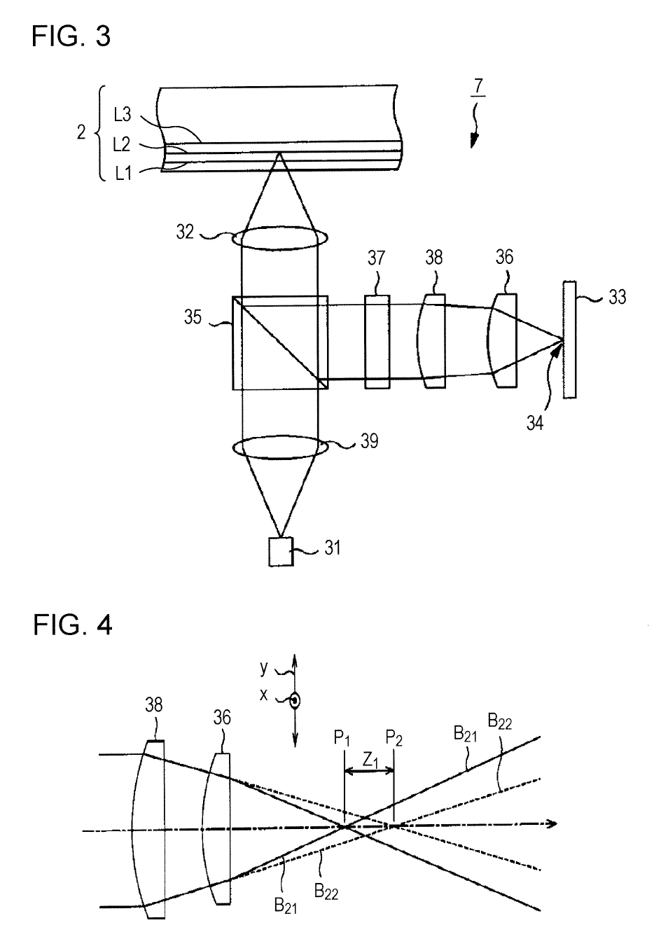

The optical pickup to which an embodiment of the present invention is applied includes, as shown in FIG. 3, a light source 31 for emitting a light beam with a predetermined wavelength, an objective lens 32 for condensing the light beam emitted from the light source 31 on a recording layer which is the signal recording surface of the optical disc 2, a photodetector 33 including a photoreception portion 34 for receiving the returned light reflected at the recording layer of the optical disc 2, a beam splitter 35 disposed between the light source 31 and the objective 32, which serves as an optical path separating unit for separating the optical path of the returned light reflected at the optical disc 2 from the optical path of a light beam emitted from the light source 31, a cylindrical lens 36 disposed between the beam splitter 35 and the photodetector 33, which serves as an astigmatism generating unit for generating astigmatism regarding a light beam to pass through, and a polarization direction adjusting unit 37 disposed between the beam splitter 35 and the cylindrical lens 36 for adjusting the polarization direction of a light beam to be divided into multiple regions, and pass through for each region.

Here, the cylindrical lens 36 can generate, as shown in FIG. 4, astigmatism regarding a light beam to pass through, and form an image in a first direction y at a first position P1 in the optical axis direction, and also form an image in a second direction x generally orthogonal to the fist direction y at a first position P2 in the optical axis direction which differs from the first position P1. Note that astigmatism means aberration wherein the image of an object point besides the optical axis is not formed as one image point, but is formed on different focal planes as a pair of right-angled lines mutually, and the positions of the different focal planes are equivalent to the above-mentioned first and second positions P1 and P2. Also, the above-mentioned first and second directions y and x are so-called astigmatic directions, which are determined based on the orientation where the cylindrical lens is disposed. Also, in other words, the first direction y is a direction where a focal line is formed at the front, and the second direction x is a direction where a focal line is formed at the back. In the drawing, a solid line B21 illustrates a state in which an image is formed in the first direction y of a light beam as viewed from the direction shown in FIG. 4 by the cylindrical lens 36 disposed as shown in FIG. 4, and a dashed line B22 illustrates a state in which an image is formed in the second direction x of a light beam as viewed from the direction orthogonal to the direction shown in FIG. 4.

Also, the optical pickup 7 includes a collimator lens 39 provided between the light source 31 and the beam splitter 35 for converting the divergence angle of a light beam emitted from the light source 31 into general parallel light, and a condenser lens 38 provided between the beam splitter 35 and the photodetector 33 for condensing the returned light beam reflected at the beam splitter 35 on the photoreception portion 34 of the photodetector 33.

The light source 31 is, for example, a semiconductor laser for emitting a laser light flux with a wavelength of 405 nm or so. Note that the wavelength of the light beam emitted from the light source 31 is not restricted to 405 nm or so, so for example, an arrangement may be made wherein a light beam with a wavelength of 650 nm or so, or 780 nm or so is emitted. Also, description will be made below regarding the case of emitting a light beam with a single wavelength, but an arrangement may be made wherein a light beam with multiple types of wavelength is emitted, or a single or multiple light source portions are provided.

The collimator lens 39 converts the divergence angle of a light beam emitted from the light source 31, and outputs this to the beam splitter 35 side as general parallel light.

The beam splitter 35 transmits the outgoing light beam entering from the collimator lens 39 as general parallel light, and emits this toward the objective lens 32 side, and also reflects the return light beam reflected at the recording layer of the optical disc 2, and entering via the objective lens 32 (hereafter, also referred to as a returning light beam) to emit this toward the polarization direction adjusting unit 37 side. Thus, the beam splitter 35 separates the optical path of the returning light beam from the optical path of the outgoing light beam, and guides this to the polarization direction adjusting unit 37, condenser lens 38, cylindrical lens 36, and photoreception portion 34 side.

With the objective lens 32, the numerical aperture NA corresponding to the type of the optical disc 2 is set, for example, the numerical aperture NA is set to 0.85 or so. The objective lens 32 condenses the light beam entered on a desired recording layer (signal recording surface) selected of the optical disc 2. With regard to the numerical aperture of the objective lens, the numerical aperture corresponding to the type of the optical disc 2 to be employed is employed, and is not restricted to 0.85 or so, for example, may be 0.6 or so, or 0.45 or so.

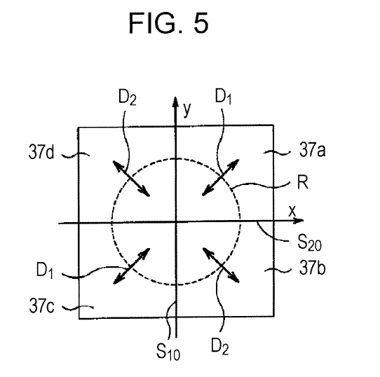

The polarization direction adjusting unit 37 is provided between the beam splitter 35 and the condenser lens 38, as shown in FIG. 5, includes first through fourth regions 37a, 37b, 37c, and 37d by being divided into two using a first parting line S10 formed in the first direction y, and also by being divided into two using a second parting line S20 formed in the second direction x, adjusts the polarization direction of the light beam entered from the beam splitter 35 to pass through for each of the regions 37a, 37b, 37c, and 37d, and emits this to the cylindrical lens 36 side. FIG. 5 is a plan view of the polarization direction adjusting unit 37 as viewed from the incident side of the returned light beam reflected at the optical disc. In FIG. 5, a dashed line R illustrates the effective radius of a light beam to pass through. Also, here, the polarization direction adjusting unit 37 is provided between the beam splitter 35 and the condenser lens 38, but is not restricted to this, for example, may be provided between the beam splitter 35 and the cylindrical lens 36, and further, may be provided between the beam splitter 35 and the first position P1. Disposing the polarization direction adjusting unit 37 further toward the front side of the optical path than the beam splitter 35 usually causes a problem, but an arrangement is made wherein liquid crystal or the like capable of exhibiting the above-mentioned function depending on the incident polarization is employed as the polarization direction adjusting unit 37, the polarization directions of returning light and outgoing light are set so as to be orthogonal, and the above-mentioned function is exhibited so as to not affect the polarization direction of outgoing, but affect the polarization direction the returning alone, whereby the polarization direction adjusting unit 37 can be disposed further toward the front side of the optical path than the beam splitter 35. Thus, the polarization direction adjusting unit 37 can be disposed at any position within the optical path emitted from the light source 31, and detected by the photodetector 33.

The polarization direction adjusting unit 37 is, for example, made up of a wavelength plate, rotatory polarizer, or the like formed so as to polarize the polarization direction of a light beam passed through for each region of the quadrisected regions toward a predetermined direction. An arrangement may be made wherein the polarization direction adjusting unit 37 is formed by integrally combining the respective regions each made up of a wavelength plate or rotatory polarizer for polarizing the polarization direction of a light beam passed through toward a predetermined direction.

The first and third regions 37a and 37c of the polarization direction adjusting unit 37 sets the polarization direction of a light beam to be emitted passing through those regions to a first polarization direction D1. Also, the second and fourth regions 37b and 37d sets the polarization direction of a light beam to be emitted passing through those regions to a second polarization direction D2 orthogonal to the first polarization direction D1. That is to say, the polarization direction adjusting unit 37 performs adjustment such that the first polarization direction D1 of a light beam to be emitted passing through the first and third regions 37a and 37c facing in one diagonal direction, and the second polarization direction D2 of a light beam to be emitted passing through the second and fourth regions 37b and 37d facing in the other diagonal direction are orthogonalized mutually.

The condenser lens 38 is provided between the polarization direction adjusting unit 37 and the cylindrical lens 36, converts the divergence angle of a returning light beam entering from the polarization direction adjusting unit 37 side, and emits this light beam to the cylindrical lens 36 side with a predetermined convergence angle so as to converge on the photoreception portion 34 of the photodetector 33.

The cylindrical lens 36 serving as an astigmatism generating unit is provided between the condenser lens 38 and the photodetector 33, generates astigmatism as to the light beam emitted from the polarization direction adjusting unit 37, and as shown in FIG. 4, forms an image in the first direction y at the first position P1 in the optical axis direction to form a first focal line, and also forms an image in the second direction x at the second position P2 in the optical axis direction at the photodetector side which is further toward the back in the advancing direction than the first position P1 to form a second focal line. Here, the first and second directions y and x are not restricted to particular directions as long as they are generally orthogonalized mutually, but for example, employing directions generally inclined 45 degrees as to the tangential direction of an optical disc and the radial direction of the optical disc enables the cylindrical lens 36 to be shared as an element for generating astigmatism to detect a focus error signal employing a so-called astigmatism method.

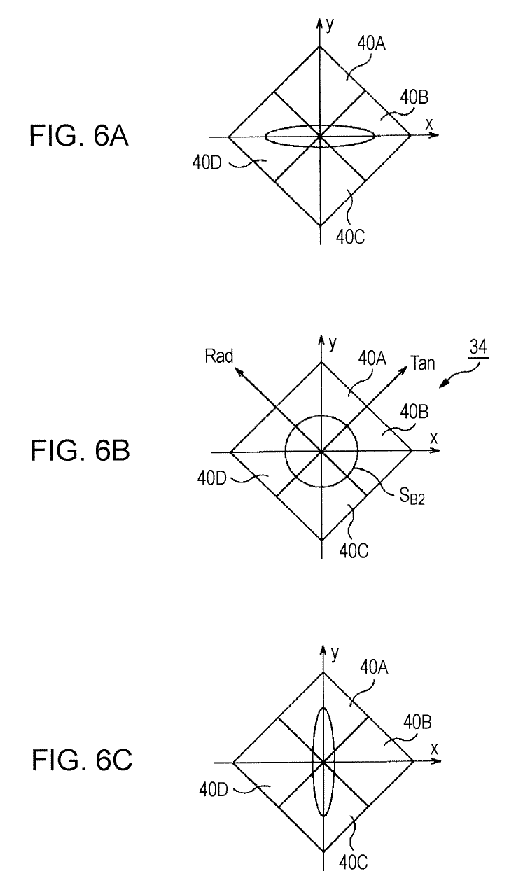

Now, description will be made with reference to FIG. 6 regarding that a focus error signal employing an astigmatism method can be detected in the event of assuming the first and second directions y and x as directions generally inclined 45 degrees as to the tangential direction Tan and the radial direction Rad of the optical disc 2.

The photoreception portion 34 for detecting a focus error signal employing an astigmatism method is, for example, such as shown in FIG. 6A, configured as a so-called split photodetector made up of photoreception regions 40A, 40B, 40C, and 40D each divided into two by the parting lines of the tangential direction Tan and the radial direction Rad.

If we say that with the photodetector 33, the output of the returned light from each of the respective photoreception regions 40A, 40B, 40C, and 40D of the photoreception portion 34 is A, B, C, and D, a focus error signal FE is calculated with relational expression FE=(A+C)−(B+D).

That is to say, as shown in FIG. 6B, in the event of a perfectly-focused state in which the objective lens 32 is disposed in the focusing position, the focus error signal FE becomes zero.

On the other hand, when the objective lens 32 approaches the optical disc 2 too much, as shown in FIG. 6A, the light quantity entering the photoreception regions 40A, 40B, 40C, and 40D is small at the regions 40A and 40C, and is large at the regions 40B and 40D, and the focus error signal FE becomes negative. Also, when the objective lens 32 is too far away from the optical disc 2, as shown in FIG. 6C, the light quantity entering the photoreception regions 40A, 40B, 40C, and 40D is large at the regions 40A and 40C, and is small at the regions 40B and 40D, and the focus error signal FE becomes positive. Accordingly, as described above, the focus error signal of employing an astigmatism method is obtained, and thus the focusing position of the objective lens 32 can be appropriately controlled.

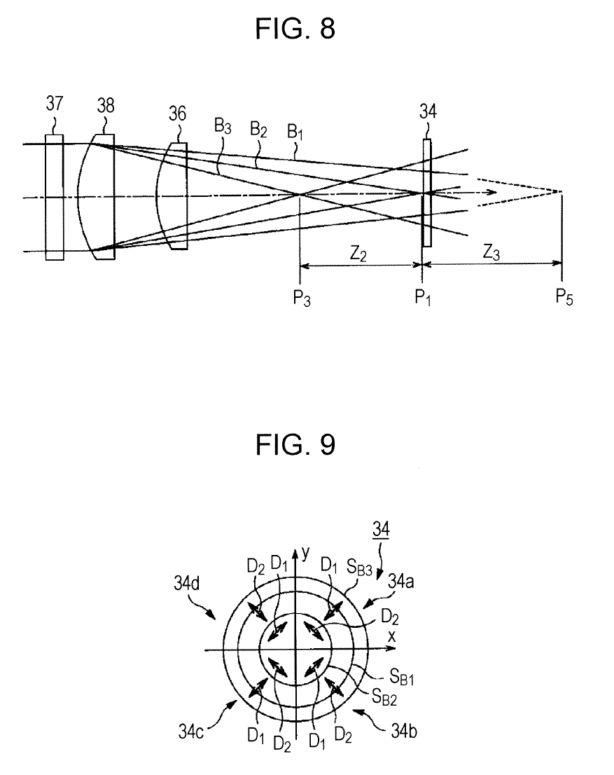

Also, the cylindrical lens 36 is configured so as to generate aberration amount such that the interval of two focal lines image-formed on the above-mentioned first and second positions P1 and P2 is smaller than the focusing point interval of light reflected at each reflection layer. Here, the focusing point interval as stated here means, for example, the interval between the focusing position of the returned light beam reflected at a recording layer where recording or playback of information is performed, and the focusing positions of the returned light beams reflected at the other layers which are different from that recording layer, or the surface. That is to say, the cylindrical lens 36 is configured such that the interval Z1 between the first position P1 and the second position P2 shown in FIG. 4 is smaller than each of the intervals Z2 and Z3 between the focusing position P1 of the returned light from a later-described focus recording layer shown in FIG. 8 and the focusing positions P3 and P5 of the returned light from the other recording layers. Note here that with the focusing position of the returned light from the focus recording layer, and the focusing positions of the returned light from the other recording layers, there are a front focusing position and a back focusing position depending on the astigmatism each provided, and the focusing position intervals Z2 and Z3 are stipulated with the respective front focusing positions P3 and P5, but are not restricted to those, and these focusing position intervals may be stipulated with each of the back focusing positions, and further this focusing position interval may be stipulated with the intermediate point of the respective front and back focusing positions.

Note here that an arrangement is made wherein the cylindrical lens 36 is employed as an astigmatism generating unit, but the astigmatism generating unit making up the optical pickup to which an embodiment of the present invention is applied is not restricted to this, so for example, may be a diffraction element, a liquid crystal optical element, or the like, and further may be another element for generating astigmatism, or the like.

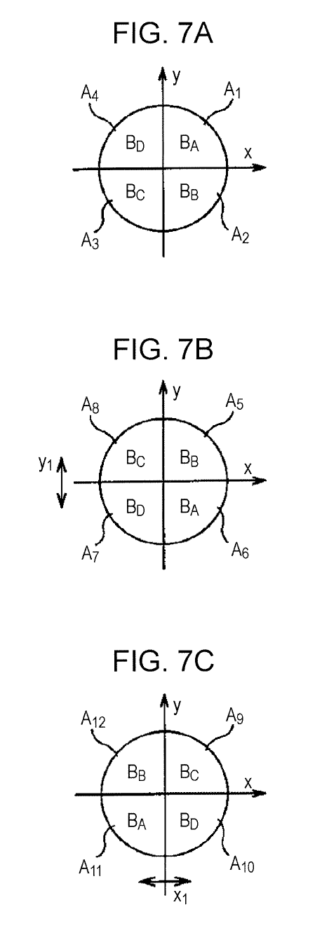

The light beam passing through the condenser lens 38 and the cylindrical lens 36, of which the polarization direction has been adjusted by the polarization direction adjusting unit 37, further passes through the second position P2, thereby being inverted in the first direction y as to the center line orthogonal to the first direction y. That is to say, as shown in FIGS. 7A and 7B, the light beam at the front of the first position P1 and the light beam at the back side of the first position P1 are symmetrical in the vertical direction which is the first direction y.

Also, the light beam passing through the condenser lens 38 and the cylindrical lens 36, of which the polarization direction has been adjusted by the polarization direction adjusting unit 37, further passes through the second position P2, thereby being inverted in the second direction x as to the center line orthogonal to the second direction x. That is to say, as shown in FIGS. 7B and 7C, the light beam at the front of the second position P2 and the light beam at the back side of the second position P2 are symmetrical in the horizontal direction which is the second direction x.

The light beam of which the polarization state has been adjusted by the polarization direction adjusting unit 37 is condensed by the condenser lens 38 and the cylindrical lens 36, and as the first through third states shown in each FIGS. 7A, 7B, and 7C according to the position of the optical axis direction thereof, the light beams passing through the respective regions 37a through 37d of the polarization direction adjusting unit 37 are interchanged, and the distribution of the polarization state thereof changes.

That is to say, the light beam is in the first state showing a state of the front of a focal line such as shown in FIG. 7A up to the first position P1 after being emitted from the polarization direction adjusting unit 37, and is in the second state showing between focal lines such as shown in FIG. 7B between the first position P1 and the second position P2, and is in the third state showing a state further toward the back than the focal line such as shown in FIG. 7C further toward the back in the advancing direction of the returned light than the position P2.

That is to say, with regard to the first state which is a state up to the first position P1 after being emitted from the polarization direction adjusting unit 37, as shown in FIG. 7A, description will be made by dividing into a first portion A1 which is a region corresponding to the first region 37a of the polarization direction adjusting unit 37, a second portion A2 which is a region corresponding to the second region 37b of the polarization direction adjusting unit 37, a third portion A3 which is a region corresponding to the third region 37c of the polarization direction adjusting unit 37, and a fourth portion A4 which is a region corresponding to the fourth region 37d of the polarization direction adjusting unit 37. Here, a light beam to pass through the first portion A1 is a light beam BA which has passed through the first region 37a of the polarization direction adjusting unit 37, a light beam to pass through the second portion A2 is a light beam BB which has passed through the second region 37b of the polarization direction adjusting unit 37, a light beam to pass through the third portion A3 is a light beam BC which has passed through the third region 37c of the polarization direction adjusting unit 37, and a light beam to pass through the first portion A4 is a light beam BD which has passed through the fourth region 37d of the polarization direction adjusting unit 37. That is to say, in the first state, with the light beams BA and BC passing through the first and third portions A1 and A3, the polarization state is set to a first polarization direction D1. Also, with the light beams BB and BD passing through the second and fourth portions A2 and A4, the polarization state is set to a second polarization direction D2.

The “region corresponding to” as stated here means a region disposed in a position facing the optical axis direction (later-described “region corresponding to” also means the same), of multiple regions divided by parting lines formed in the first and second directions y and x which are the same directions within planes generally orthogonal to the optical axis direction, i.e., the regions corresponding to the respective regions 37a, 37b, 37c, and 37d of the polarization direction adjusting unit 37 are regions divided by parting lines formed in the position where the parting lines for forming the respective regions 37a through 37d are moved in parallel in the optical axis direction within planes generally orthogonal to the optical axis direction in a position separated by predetermined distance alone in the optical axis direction from the polarization direction adjusting unit 37, and also regions disposed in the positions facing the corresponding respective regions 37a through 37d in the optical axis direction.

Also, with regard to the second state which is a state from the first position P1 to the second position P2, description will be made by dividing into a fifth portion A5 which is a region corresponding to the first region 37a of the polarization direction adjusting unit 37, a sixth portion A6 which is a region corresponding to the second region 37b of the polarization direction adjusting unit 37, a seventh portion A7 which is a region corresponding to the third region 37c of the polarization direction adjusting unit 37, and an eighth portion A8 which is a region corresponding to the fourth region 37d of the polarization direction adjusting unit 37. Here, a light beam to pass through the fifth portion A5 is the light beam BB which has passed through the second region 37b of the polarization direction adjusting unit 37, and has been the second portion A2 in the first state, a light beam to pass through the sixth portion A6 is the light beam BA which has passed through the first region 37a of the polarization direction adjusting unit 37, and has been the first portion A1 in the first state, a light beam to pass through the seventh portion A7 is the light beam BD which has passed through the fourth region 37d of the polarization direction adjusting unit 37, and has been the fourth portion A4 in the first state, and a light beam to pass through the eighth portion A8 is the light beam BC which has passed through the third region 37c of the polarization direction adjusting unit 37, and has been the third portion A3 in the first state. That is to say, in the second state, with the light beams BB and BD passing through the fifth and seventh portions A5 and A7, the polarization state is set to the second polarization direction D2. Also, with the light beams BA and BC passing through the sixth and eighth portions A6 and A8, the polarization state is set to the first polarization direction D1.

Also, with regard to the third state which is a state further toward the back than the second position P2, description will be made by dividing into a ninth portion A9 which is a region corresponding to the first region 37a of the polarization direction adjusting unit 37, a tenth portion A10 which is a region corresponding to the second region 37b of the polarization direction adjusting unit 37, an eleventh portion A11 which is a region corresponding to the third region 37c of the polarization direction adjusting unit 37, and a twelfth portion A12 which is a region corresponding to the fourth region 37d of the polarization direction adjusting unit 37. Here, a light beam to pass through the ninth portion A9 is the light beam BC which has passed through the third region 37c of the polarization direction adjusting unit 37, and has been the third portion A3 in the first state, and has been the eighth portion A8, a light beam to pass through the tenth portion A10 is the light beam BD which has passed through the fourth region 37d of the polarization direction adjusting unit 37, and has been the fourth portion A4 in the first state, and has been the seventh portion A7 in the second state, a light beam to pass through the eleventh portion A11 is the light beam BA which has passed through the first region 37a of the polarization direction adjusting unit 37, and has been the first portion A1 in the first state, and has been the sixth portion A6, and a light beam to pass through the twelfth portion A12 is the light beam BB which has passed through the second region 37b of the polarization direction adjusting unit 37, and has been the second portion A2 in the first state, and has been the fifth portion A5 in the second state. That is to say, in the third state, with the light beams BC and BA passing through the ninth and eleventh portions A9 and A11, the polarization state is set to the first polarization direction D1. Also, with the light beams BD and BB passing through the tenth and twelfth portions A10 and A12, the polarization state is set to the second polarization direction D2.

The photodetector 33 includes a photoreceptor where the photoreception portion 34, which is formed in a generally square shape, and provided at the center portion, for receiving and detecting an incident light beam, and detects the received light beam at the photoreception portion 34 of the photoreceptor. Also, the photodetector 33 is disposed between the first focal line and the second focal line which are condensed by the above-mentioned condenser lens 38 and the cylindrical lens 36, i.e., disposed between the first position P1 and the second position P2. Accordingly, the light beam reflected at the recording layer where recording or playback of information is performed (hereafter, also referred to as a focus recording layer) is accordingly detected in the above-mentioned second state.

With the photodetector 33, the photoreception portion 34 is configured as a so-called split photodetector for receiving the light beam condensed by the condenser lens 38 and the cylindrical lens 36, and detecting various types of signal such as a tracking error signal, a focusing error signal, and so forth as well as an information signal, and detects various types of signal such as an information signal, a tracking error signal, a focusing error signal, and so forth.

With the optical pickup thus configured, upon a light beam being emitted from the light source 31, the light beam is converted into parallel light by the collimator lens 39, transmitted to the objective lens 32 side by the beam splitter 35, and condensed by the objective lens 32 to form a spot on the focus recording layer of the optical disc 2. The light beam condensed on the recording layer of the optical disc 2 is reflected and enters the beam splitter 35 again, whereby the optical path is changed by the beam splitter 35, and condensed on the photoreception portion 34 of the photodetector 33 via the polarization direction adjusting unit 37, condenser lens 38, and cylindrical lens 36.

At this time, for example, in the event that the light beam is condensed on a single recording layer L2 which is a focus recording layer, as shown in FIG. 8, a light beam B2 condensed and reflected at the focus recording layer L2 is condensed on the photoreception portion 34 so as to form a first focal line at the front of the photoreception portion 34 of the photodetector 33 via the condenser lens 38 and the cylindrical lens 36, and also form a second focal line at the back of the photoreception portion 34. With regard to FIG. 8, unlike the case of FIG. 4, of the first and second focal lines, the first focal line alone formed at the front is shown in the position P1 thereof, for the sake of description. Similarly, of later-described third through sixth focal lines, only the third and fifth focal lines formed at the front are each shown in positions P3 and P5 in the optical axis direction.

At the same time, a light beam B3 reflected at the recording layer L3 which is further toward the back side than the focus recording layer L2 also enters the photoreception portion 34 of the photodetector 33 via the condenser lens 38 and the cylindrical lens 36 as unwanted light, involuntarily. At this time, the light beam B3 reflected at the back recording layer L3 forms third and fourth focal lines corresponding to the first and second focal lines at the front of the photoreception portion 34, and then enters on the photoreception portion 34.

Also, a light beam B1 reflected at the recording layer L1 which is further toward the front side than the focus recording layer L2 also enters the photoreception portion 34 of the photodetector 33 via the condenser lens 38 and the cylindrical lens 36 as unwanted light, involuntarily. At this time, the light beam B1 reflected at the front recording layer L1 enters on the photoreception portion 34 so as to form fifth and sixth focal lines corresponding to the first and second focal lines at the back of the photoreception portion 34.

Accordingly, as shown in FIG. 9, the light beam B2 returning from the focus recording layer L2 is, as described above, condensed on the photoreception portion 34 in the second state shown in FIG. 7B. Also, the light beam B3 returning from the back recording layer L3 enters on the photoreception portion 34 further toward the back side than the position where the fourth focal line which is a back focal line is formed, so this position corresponds to a position further toward the back side than the above-mentioned second position P2, and accordingly, the light beam B3 enters on the photoreception portion 34 in the third state shown in FIG. 7C. Also, the light beam B1 returning from the front recording layer L1 enters on the photoreception portion 34 further toward the front side than the position where the fifth focal line which is a front focal line is formed, so this position corresponds to a position further toward the front side than the above-mentioned first position P1, and accordingly, the light beam B1 enters on the photoreception portion 34 in the first state shown in FIG. 7A.

Description has been made here regarding the case of selecting the recording layer L2 of the middle of a so-called three-layer optical disc including three recording layers as a focus recording layer, but in the event of having selecting any of the other recording layers L1 and L3 as a focus recording layer, the interval Z1 between the first position P1 and the second position P2 shown in FIG. 4 is determined by regarding the recording layer of the back of the focus recording layer, and the recording layer of the front of the focus recording layer or the surface in the case of no recording layer at the front of the focus recording layer as the other recording layers.

Also, description has been made here assuming that a so-called three-layer optical disc including three recording layers is employed, but an arrangement may be made wherein an optical disc including a single recording layer is subjected to recording and/or playback of information, and in this case, the cylindrical lens 36 is formed such that the interval Z1 between the first position P1 and the second position P2 shown in FIG. 4 is smaller than the interval between the focusing position of returned light from the focus recording layer and the focusing position of returned light from the surface. Also, an arrangement may be made wherein an optical disc including two or four or more recording layers is subjected to recording and/or playback of information.

The optical pickup 7 can prevent interference between the light beam returning from the focus recording layer condensed on the photoreception portion 34, and the light beams returning from the back and front recording layers (hereafter, also referred to as “other recording layers and the like”) entered on the photoreception portion 34 by providing the above-mentioned cylindrical lens 36 and polarization direction adjusting unit 37, and description will be made below in detail regarding in that this interference can be prevented. Hereafter, description will be made regarding the light beam returning from the focus recording layer, and the light beams returning from the other recording layers and the like for each region on the photoreception portion 34 corresponding to each region of the polarization direction adjusting unit 37.

Specifically, study will be made, as shown in FIG. 9, by dividing the photoreception portion 34 into a fifth region 34a corresponding to the first region 37a of the polarization direction adjusting unit 37, a sixth region 34b corresponding to the second region 37b of the polarization direction adjusting unit 37, a seventh region 34c corresponding to the third region 37c of the polarization direction adjusting unit 37, and an eighth region 34d corresponding to the fourth region 37d of the polarization direction adjusting unit 37. Note that the regions 34a through 34d may be a quadrisected detector configured so as to detect returned light independently as a photoreception portion, or may be a detector which is not actually divided. Note that in FIG. 9, SB2 represents a spot condensed on the photoreception portion 34 of the light beam B2 reflected at the focus recording layer L2, SB3 represents a spot entered on the photoreception portion 34 of the light beam B3 reflected at the recording layer L3 which is further toward the back than the focus recording layer L2, and SB1 represents a spot entered on the photoreception portion 34 of the light beam B1 reflected at the recording layer L1 which is further toward the front than the focus recording layer L2.

With the fifth region 34a of the photoreception portion 34, as shown in FIG. 9, the light beam from the focus recording layer enters in the state of the second polarization direction D2, and also the light beams from the other recording layers enter in the state of the first polarization direction D1, and thus the light beam from the focus recording layer and the light beams from the other recording layers which are unwanted light are overlapped, but do not interfere.

With the sixth region 34b of the photoreception portion 34, as shown in FIG. 9, the light beam from the focus recording layer enters in the state of the first polarization direction D1, and also the light beams from the other recording layers enter in the state of the second polarization direction D2, and thus the light beam from the focus recording layer and the light beams from the other recording layers which are unwanted light are overlapped, but do not interfere.

With the seventh region 34c of the photoreception portion 34, as shown in FIG. 9, the light beam from the focus recording layer enters in the state of the second polarization direction D2, and also the light beams from the other recording layers enter in the state of the first polarization direction D1, and thus the light beam from the focus recording layer and the light beams from the other recording layers which are unwanted light are overlapped, but do not interfere.

With the eighth region 34d of the photoreception portion 34, as shown in FIG. 9, the light beam from the focus recording layer enters in the state of the first polarization direction D1, and also the light beams from the other recording layers enter in the state of the second polarization direction D2, and thus the light beam from the focus recording layer and the light beams from the other recording layers which are unwanted light are overlapped, but do not interfere.

As described above, the optical pickup 7 to which an embodiment of the present invention is applied includes the light source 31, objective lens 32, photodetector 33, beam splitter 35, cylindrical lens 36, and polarization direction adjusting unit 37, causes the cylindrical lens 36 to generate astigmatism regarding a light beam to pass through, form an image in the first direction y at the first position P1 in the optical axis direction, and also form an image in the second direction x at the second position P2 in the optical axis direction. The polarization direction adjusting unit 37 includes the first through fourth regions 37a through 37d divided by the parting lines S10 and S20 formed in the first and second directions y and x, and performs adjustment such that the first polarization direction D1 of the light beam to be emitted passing through the regions 37a and 37c facing one diagonal direction, and the second polarization direction D2 of the light beam to be emitted passing through the regions 37b and 37d facing the other diagonal direction are orthogonalized mutually, whereby the polarization direction of the light beam reflected at the focus recording layer, and the polarization directions of the light beams reflected at the other recording layers or the surface, which are condensed on the photoreception portion 34, can be orthogonalized. Accordingly, with the optical pickup 7, even in the event that the light beam reflected at the other recording layers or the surface enter as stray light, and overlap the light beam condensed on the photoreception portion 34 of the photodetector 33, and reflected at the focus recording layer, no interference occurs, and accordingly, noise components can be prevented from occurring within a signal detected from the light returning from the focus recording layer.

Particularly, with an optical disc employing a short wavelength, the distance between layers can be reduced, and in the event that the distance between layers is short, particularly the influence of the stray light causes a problem, but with the optical pickup 7, employing the simple configuration enables noise components to be reduced markedly when an optical disc employing a short wavelength is configured of a multi-layer configuration, mass-storage recoding capacity, and excellent recording playback due to prevention of the stray light.

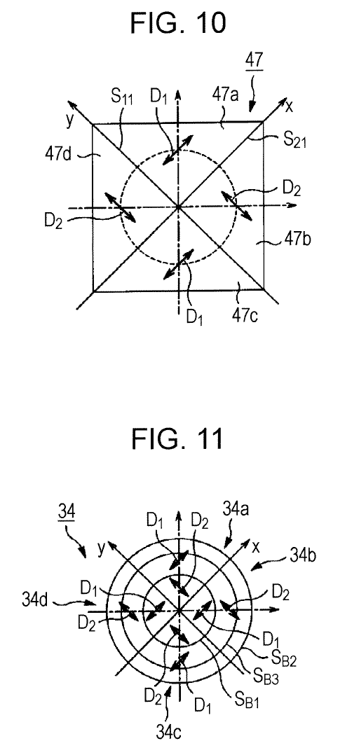

Note that with the above-mentioned optical pickup 7, as shown in FIG. 5 described above, an arrangement has been made wherein the polarization direction adjusting unit 37 in a generally rectangle wherein each of the sides is formed in the first direction y or the second direction x is quadrisected in a generally rectangle by the parting line S10 formed in the first direction y, and the parting line S20 formed in the second direction x to provide the respective regions 37a through 37d, but the arrangement is not restricted to this, so for example, as shown in FIG. 10, an arrangement may be made wherein the polarization direction adjusting unit 47 in a generally rectangle formed by each of the sides being generally inclined 45 degrees as to the first direction y and the second direction x is configured so as to include first through fourth regions 47a, 47b, 47c, and 47d, by being divided into two by a parting line S11 formed in the first direction y, and also divided into two by a parting line S21 formed in the second direction x, and with regard to the light beam entered from the beam splitter 35, the polarization direction of the light beam to pass through is adjusted for each of the regions 47a through 47d, as with the above-mentioned polarization direction adjusting unit 37, such that the first polarization direction D1 of a light beam to be emitted passing through the regions 47a and 47c facing one diagonal direction, and the second polarization direction D2 of a light beam passing through the regions 47b and 47d facing the other diagonal direction are orthogonalized mutually.

With regard to a case wherein the polarization direction adjusting unit 47 shown in FIG. 10 is provided instead of the polarization direction adjusting unit 37 shown in FIG. 5 as well, the light beam from the focus recording layer, and the light beams from the other recording layers enter the fifth through eighth regions 34a through 34d of the photoreception portion 34 such as shown in FIG. 11, so no interference occurs, and accordingly, noise components can be prevented from occurring within a signal detected from the light returning from the focus recording layer.

Note that with the above description, an arrangement has been made wherein the cylindrical lens 36 serving as an astigmatism generating unit and the polarization direction adjusting unit 37 are provided, thereby preventing the interference between the returned light from the focus recording layer and the returned light from the other recording layers and the like on the photoreception portion 34, but further, as shown below, an arrangement may be made wherein there is provided a polarizer including multiple regions for transmitting or polarizing depending on the polarization state of a light beam to enter for each of the regions.

Next, description will be made regarding an optical pickup including a polarizer having multiple regions for transmitting or polarizing depending on the polarization state of a light beam to enter for each of the regions. Note that with the following description, the components common to those of the above-mentioned optical pickup 7 are appended with the common reference numerals, and also detailed description thereof will be omitted.

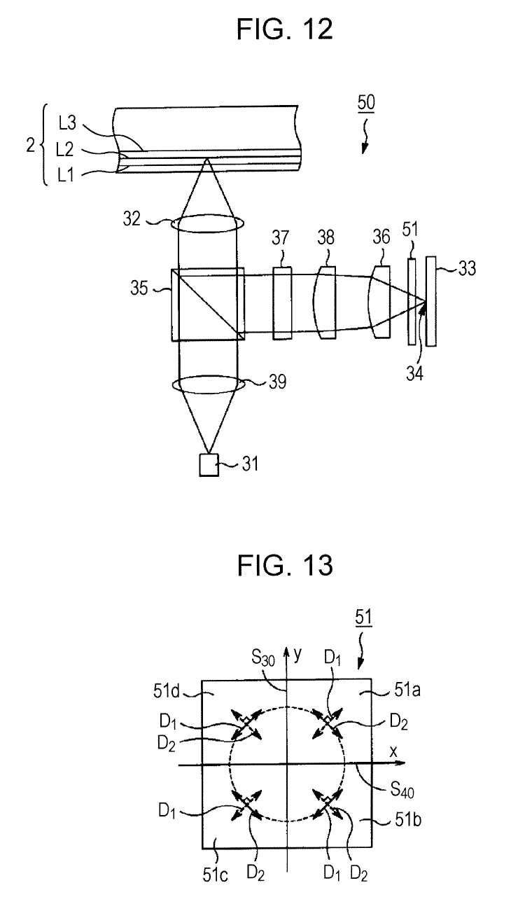

An optical pickup 50 to which an embodiment of the present invention is applied includes, as shown in FIG. 12, the light source 31, objective lens 32, photodetector 33, beam splitter 35, cylindrical lens 36, polarization direction adjusting unit 37, collimator lens 39, condenser lens 38, and a polarizer 51, which is provided between the cylindrical lens 36 and the photodetector 33 and divided into multiple regions, for transmitting or polarizing depending on the polarization state of a light beam to enter for each of the regions.

The polarizer 51 includes, as shown in FIG. 13, ninth through twelfth regions 51a, 51b, 51c, and 51d by being divided into two with a third parting line S30 formed in the first direction y, and also by being divided into two with a fourth parting line S40 formed in the second direction x, and transmits or reflects the light beam emitted from the cylindrical lens 36 and entered the polarizer 51 for each of the regions depending on the polarization sate of the light beam.

The ninth region 51a is a region corresponding to the first region 37a of the polarization direction adjusting unit 37, reflects the light beam in the first polarization direction D1, and also transmits the light beam in the second polarization direction D2. Also, the tenth region 51b is a region corresponding to the second region 37b of the polarization direction adjusting unit 37, transmits the light beam in the first polarization direction D1, and also reflects the light beam in the second polarization direction D2. Also, the eleventh region 51c is a region corresponding to the third region 37c of the polarization direction adjusting unit 37, reflects the light beam in the first polarization direction D1, and also transmits the light beam in the second polarization direction D2. Further, the twelfth region 51d is a region corresponding to the fourth region 37d of the polarization direction adjusting unit 37, transmits the light beam in the first polarization direction D1, and also reflects the light beam in the second polarization direction D2. Note that in FIG. 13, a solid line arrow represents the polarization direction of a light beam transmitting the region thereof, and a dashed line arrow represents the polarization direction of a light beam reflected the region thereof.

That is to say, of the light beams entering the ninth and eleventh regions 51a and 51c corresponding to the regions 37a and 37c facing one diagonal direction of the polarization direction adjusting unit 37, the polarizer 51 reflects the light beams in the first polarization direction D1, and transmits the light beams in the second polarization direction D2 toward the photoreception portion 34 side of the photodetector 33. Also, of the light beams entering the tenth and twelfth regions 51b and 51d corresponding to the regions 37b and 37d facing the other diagonal direction of the polarization direction adjusting unit 37, the polarizer 51 transmits the light beams in the first polarization direction D1 toward the photoreception portion 34 side of the photodetector 33, and reflects the light beams in the second polarization direction D2. Also, the polarizer 51 is disposed between the first focal line and the second focal line which are condensed by the condenser lens 38 and the cylindrical lens 36, i.e., disposed between the first position P1 and the second position P2. Accordingly, the light beam reflected at the focus recording layer enters the polarizer 51 in the second state such as shown in FIG. 7B.

With the optical pickup 50 thus configured, upon a light beam being emitted from the light source 31, the light beam is converted into parallel light by the collimator lens 39, transmitted to the objective lens 32 side by the beam splitter 35, and condensed by the objective lens 32 to form a spot on the focus recording layer of the optical disc 2. The light beam condensed on the recording layer of the optical disc 2 is reflected and entered in the beam splitter 35 again, of which the optical path is changed by the beam splitter 35, and condensed on the photoreception portion 34 of the photodetector 33 via the polarization direction adjusting unit 37, condenser lens 38, cylindrical lens 36, and polarizer 51.

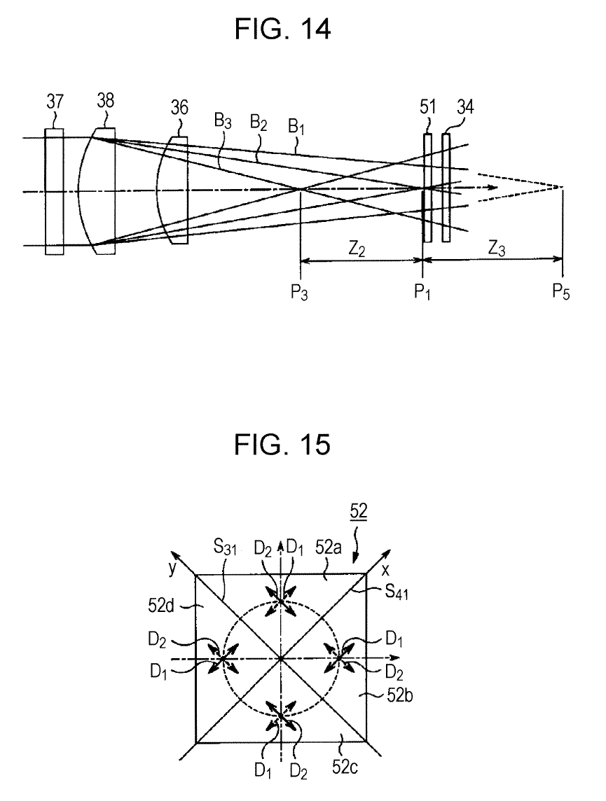

At this time, for example, in the event that the light beam is condensed on a single recording layer L2 which is a focus recording layer, as shown in FIG. 14, a light beam B2 condensed and reflected at the focus recording layer L2 is condensed on the photoreception portion 34 so as to form a first focal line at the front of the polarizer 51 via the condenser lens 38 and the cylindrical lens 36, and also form a second focal line at the back of the polarizer 51. With the optical pickup 50 wherein the polarizer 51 is provided, the photoreception portion 34 needs to be disposed further toward the back side than the polarizer 51 disposed between the first position P1 and the second position P2, but in the event of detecting a focus error signal employing the astigmatism method as described above, as with the polarizer 51, the photoreception portion 34 needs to be disposed between the first position P1 and the second position P2. In FIG. 14, the positions P1, P3, and P5 are the same as those in FIG. 8, so description thereof will be omitted here.

At the same time, a light beam B3 reflected at the recording layer L3 which is further toward the back side than the focus recording layer L2 also enters the polarizer 51 via the condenser lens 38 and the cylindrical lens 36, involuntarily. At this time, the light beam B3 reflected at the back recording layer L3 forms third and fourth focal lines corresponding to the first and second focal lines at the front of the polarizer 51, and then enters the polarizer 51.

Also, a light beam B1 reflected at the recording layer L1 which is further toward the front side than the focus recording layer L2 also enters the photoreception portion 34 of the photodetector 33 via the condenser lens 38 and the cylindrical lens 36 as unwanted light, involuntarily. At this time, the light beam B1 reflected at the front recording layer L1 enters the polarizer 51 so as to form fifth and sixth focal lines corresponding to the first and second focal lines at the back of the polarizer 51.

Accordingly, as with the case of the above description with reference to FIG. 9, the light beam B2 returning from the focus recording layer L2 enters the polarizer 51 in the second state shown in FIG. 7B as described above. Also, the light beam B3 returning from the back recording layer L3 enters the polarizer 51 further toward the back side than the position where the fourth focal line which is a back focal line is formed, so this position corresponds to a position further toward the back side than the above-mentioned second position P2, and accordingly, the light beam B3 enters the polarizer 51 in the third state shown in FIG. 7C. Also, the light beam B1 returning from the front recording layer L1 enters the polarizer 51 further toward the front side than the position where the fifth focal line which is a front focal line is formed, so this position corresponds to a position further toward the front side than the above-mentioned first position P1, and accordingly, the light beam B1 enters on the polarizer 51 in the first state shown in FIG. 7A.

Description has been made here regarding the case of selecting the recording layer L2 as a focus recording layer, but any of the other recording layers L1 and L3 may be selected as a focus recording layer, and also an arrangement may be made wherein an optical disc including a single or multiple recording layers is subjected to recording and/or playback of information, which are the same as the above description.

The optical pickup 50 includes the above-mentioned cylindrical lens 36 and polarization direction adjusting unit 37, and also includes the polarizer 51, whereby in addition to the light beam returning from the focus recording layer condensed on the photoreception portion 34, the light beams returning from the other recording layers is prevented from entering on the photoreception portion 34 as stray light, and accordingly, interference between the light beam returning from the focus recording layer condensed on the photoreception portion 34, and the light beams returning from the other recording layers entered on the photoreception portion 34 can be prevented. Now, description will be made below in detail regarding that the interference can be prevented by preventing the light beams from the other recording layers from entering as stray light.

The light beam from the focus recording layer L2 enters the ninth region 51a of the polarizer 51 in the state of the second polarization direction D2 as with the light beam condensed on the photodetector 33 which has been described with reference to FIG. 9 in the case of the above-mentioned optical pickup 7, and also the light beams from the other recording layers L1 and L3 enter the ninth region 51a in the state of the first polarization direction D1, and thus, the light beam from the focus recording layer is transmitted to enter on the photoreception portion 34, and also the light beams from the other recording layers are reflected, thereby preventing the unwanted light from entering on the photoreception portion 34, resulting in no interference.

The light beam from the focus recording layer L2 enters the tenth region 51b of the polarizer 51 in the state of the first polarization direction D1, and also the light beams from the other recording layers L1 and L3 enter the tenth region 51b in the state of the second polarization direction D2, and thus, the light beam from the focus recording layer is transmitted to enter on the photoreception portion 34, and also the light beams from the other recording layers are reflected, thereby preventing the unwanted light from entering on the photoreception portion 34, resulting in no interference.

The light beam from the focus recording layer L2 enters the eleventh region 51c of the polarizer 51 in the state of the second polarization direction D2, and also the light beams from the other recording layers L1 and L3 enter the eleventh region 51c in the state of the first polarization direction D1, and thus, the light beam from the focus recording layer is transmitted to enter on the photoreception portion 34, and also the light beams from the other recording layers are reflected, thereby preventing the unwanted light from entering on the photoreception portion 34, resulting in no interference.

The light beam from the focus recording layer L2 enters the twelfth region 51d of the polarizer 51 in the state of the first polarization direction D1, and also the light beams from the other recording layers L1 and L3 enter the twelfth region 51d in the state of the second polarization direction D2, and thus, the light beam from the focus recording layer is transmitted to enter on the photoreception portion 34, and also the light beams from the other recording layers are reflected, thereby preventing the unwanted light from entering on the photoreception portion 34, resulting in no interference.

Thus, the polarizer 51 can transmit the light beam reflected at the focus recording layer with the polarization direction being adjusted for each of the regions 37a through 37d by the polarization direction adjusting unit 37, and can reflect the light beam reflected at the other recording layers and the like with the polarization direction being adjusted for each region by the polarization direction adjusting unit 37.

As described above, the optical pickup 50 to which an embodiment of the present invention is applied includes the light source 31, objective lens 32, photodetector 33, beam splitter 35, cylindrical lens 36, and polarization direction adjusting unit 37, causes the cylindrical lens 36 to generate astigmatism regarding a light beam to pass through, form an image in the first direction y at the first position P1 in the optical axis direction, and also form an image in the second direction x at the second position P2 in the optical axis direction. The polarization direction adjusting unit 37 includes the first through fourth regions 37a through 37d divided by the parting lines S10 and S20 formed in the first and second directions y and x, and performs adjustment such that the first polarization direction D1 of the light beam to be emitted passing through the regions facing one diagonal direction, and the second polarization direction D2 of the light beam to be emitted passing through the regions facing the other diagonal direction are orthogonalized mutually. The polarizer 51, of the light beams entering the regions 51a and 51c corresponding to the regions 37a and 37c facing one diagonal direction of the polarization direction adjusting unit 37, reflects the light beams in the first polarization direction D1, and transmits the light beams in the second polarization direction D2, and of the light beams entering the regions 51b and 51d corresponding to the regions 37b and 37d facing the other diagonal direction of the polarization direction adjusting unit 37, transmits the light beams in the first polarization direction D1, and reflects the light beams in the second polarization direction D2, and accordingly, of the light beams entering each region of the polarizer 51 disposed immediately before the photoreception portion 34, the polarization direction of the light beam reflected at the focus recording layer can be taken as the polarization direction transmitting each of the regions of the polarizer 51, and the polarization direction of the light beams reflected at the other recording layers or the surface can be taken as the polarization direction reflected at each of the regions of the polarizer 51.

Accordingly, with the optical pickup 50, the light beams reflected at the other recording layers or the surface are prevented from entering as stray light as to the light beam reflected at the focus recording layer, which are condensed on the photoreception portion 34 of the photodetector 33, and the interference between the light beam reflected at the focus recording layer and the light beams reflected at the other recording layers or the surface is prevented from occurring, whereby noise components can be prevented from occurring within a signal detected from the light returning from the focus recording layer.

Note that with the above-mentioned optical pickup 50, as shown in FIG. 13 described above, an arrangement has been made wherein the polarizer 51 in a generally rectangle wherein each of the sides is formed in the first direction y or the second direction x is quadrisected in a generally rectangle by the parting line S30 formed in the first direction y, and the parting line S40 formed in the second direction x to provide the respective regions 51a through 51d, but the arrangement is not restricted to this, so for example, as shown in FIG. 15, an arrangement may be made wherein a polarizer 52 in a generally rectangle formed by each of the sides being generally inclined 45 degrees as to the first direction y and the second direction x is configured so as to include ninth through twelfth regions 52a, 52b, 52c, and 52d, by being divided into two by a parting line S31 formed in the first direction y, and also divided into two by a parting line S41 formed in the second direction x, and as with the above-mentioned polarizer 51, so as to transmit or reflect the incident light beam depending on the polarization for each of the regions 52a through 52d. Note that in FIG. 15, a solid line arrow represents the polarization direction of a light beam transmitting the region thereof, and a dashed line arrow represents the polarization direction of a light beam reflected the region thereof.

That is to say, the polarizer 52 shown in FIG. 15 is employed, for example, along with the polarization direction adjusting unit 47 shown in FIG. 10 described above, the ninth region 52a of the polarizer 52 is a region corresponding to the first region 47a of the polarization direction adjusting unit 47, reflects the light beams in the first polarization direction D1, and also transmits the light beams in the second polarization direction D2. Also, the tenth region 52b is a region corresponding to the second region 47b of the polarization direction adjusting unit 47, transmits the light beams in the first polarization direction D1, and also reflects the light beams in the second polarization direction D2. Also, the eleventh region 52c is a region corresponding to the third region 47c of the polarization direction adjusting unit 47, reflects the light beams in the first polarization direction D1, and also transmits the light beams in the second polarization direction D2. Further, the twelfth region 52d is a region corresponding to the fourth region 47d of the polarization direction adjusting unit 47, transmits the light beams in the first polarization direction D1, and also reflects the light beams in the second polarization direction D2.

The polarization direction adjusting unit 47 shown in FIG. 10 is provided instead of the polarization direction adjusting unit 37 shown in FIG. 5, and also the polarizer 52 shown in FIG. 15 is provided instead of the polarizer 51 shown in FIG. 13, and thus with the ninth through twelfth regions 52a through 52d of the polarizer 52, the light beam from the focus recording layer enters in a polarization state in which the light beam is transmitted, the light beams from the other recording layers enter in a polarization state in which the light beams are reflected, and the light beams reflected at the other recording layers or the surface are prevented from entering as stray light as to the light beam reflected at the focus recording layer where recording and/or playback of information is performed, and the interference between the light beam reflected at the focus recording layer and the light beams reflected at the other recording layers or the surface is prevented from occurring, whereby noise components can be prevented from occurring within a signal detected from the light returning from the focus recording layer.

Also, the optical disc device 1 to which an embodiment of the present invention is applied is provided with the above-mentioned optical pickup 7 or 50, whereby the interference between the light beam reflected at the focus recording layer and the light beams reflected at the other recording layers or the surface is prevented from occurring, whereby noise components can be prevented from occurring within a signal detected from the light returning from the focus recording layer. Further, the optical disc device 1 realizes excellent recording/playback properties by preventing stray light as to an optical disc having a multi-layer configuration for realizing mass-storage recoding capacity.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup configured to subject an optical disc having a single or plurality of recording layers in the incidence direction of a light beam to recording and/or playback of information, comprising:
a light source configured to emit a light beam having a predetermined wavelength;
an objective lens configured to condense the light beam emitted from said light source on a recording layer of an optical disc;
a photodetector including a photoreception portion configured to receive the returned light from said optical disc;
optical path separating means, which are disposed between said light source and said objective lens, configured to separate the optical path of the returned light reflected at said optical disc from the optical path of the light beam emitted from said light source;
astigmatism generating means, which are provided between said optical path separating means and said photoreception portion, configured to generate astigmatism regarding a light beam to pass through, to form an image in a first direction at a first position in the optical axis direction, and also to form an image in a second direction generally orthogonal to said first direction at a second position in the optical axis direction which is a position different from said first position; and
polarization direction adjusting means, which include four regions obtained by being divided into two with each of the parting lines formed in said first and second directions, configured to adjust the polarization direction of a light beam to pass through for each region;
wherein said polarization direction adjusting means adjust a first polarization direction of a light beam to be emitted passing through a region facing in one diagonal direction, and a second polarization direction of a light beam to be emitted passing through a region facing in the other diagonal direction so as to be mutually orthogonal.

2. The optical pickup according to claim 1, wherein the interval between said first position where an image is formed by said astigmatism generating means, and said second position is set so as to be shorter than the focusing point interval of a light beam reflected at each recording layer or the surface of said optical disc.

3. The optical pickup according to claim 1, wherein said first direction and said second direction are inclined 45 degrees as to the tangential direction of said optical disc and the radial direction of said optical disc.

4. The optical pickup according to claim 1, wherein said polarization direction adjusting means are made up of a wavelength plate or rotatory polarizer formed so as to polarize the polarization direction of said light beam passed through for each region toward a predetermined direction, or are formed by integrating the respective regions made up of a wavelength plate or rotatory polarizer configured to polarize the polarization direction of said light beam passed through toward a predetermined direction.

5. The optical pickup according to claim 1, further comprising:
a polarizer, which is provided between said astigmatism generating means and said photoreception portion, and includes four regions obtained by being divided into two with each of the parting lines formed in said first and second directions, configured to transmit or reflect a light beam to be entered for each region depending on the polarization direction of the light beam;
wherein said polarizer, of light beams to be entered in a region corresponding to a region facing one diagonal direction of said polarization direction adjusting means, reflects a light beam in said first polarization direction, transmits a light beam in said second polarization direction, and of light beams to be entered in a region corresponding to a region facing the other diagonal direction of said polarization direction adjusting means, transmits a light beam in said first polarization direction, and reflects a light beam in said second polarization direction.

6. The optical pickup according to claim 1, further comprising:
a polarizer, which is provided between said astigmatism generating means and said photoreception portion, and includes four regions obtained by being divided into two with each of the parting lines formed in said first and second directions, configured to transmit or reflect a light beam to be entered for each region depending on the polarization direction of the light beam;
wherein said polarizer transmits a light beam reflected at a recording layer where recording or playback of information is performed, of which the polarization direction is adjusted for each region by said polarization direction adjusting means, and reflects a light beam reflected at another recording layer which is different from said recording layer where recording or playback of information is performed, or the surface, of which the polarization direction is adjusted for each region by said polarization direction adjusting means.

7. An optical disc device comprising:
an optical pickup configured to subject an optical disc having a single or plurality of recording layers in the incidence direction of a light beam to recording and/or playback of information; and
rotational driving means configured to rotate said optical disc;
wherein said optical pickup includes
a light source configured to emit a light beam having a predetermined wavelength,
an objective lens configured to condense the light beam emitted from said light source on a recording layer of an optical disc,
a photodetector including a photoreception portion configured to receive the returned light from said optical disc,
optical path separating means, which are disposed between said light source and said objective lens, configured to separate the optical path of the returned light reflected at said optical disc from the optical path of the light beam emitted from said light source,
astigmatism generating means, which are provided between said optical path separating means and said photoreception portion, configured to generate astigmatism regarding a light beam to pass through, to form an image in a first direction at a first position in the optical axis direction, and also to form an image in a second direction generally orthogonal to said first direction at a second position in the optical axis direction which is a position different from said first position, and
polarization direction adjusting means, which include four regions obtained by being divided into two with each of the parting lines formed in said first and second directions, configured to adjust the polarization direction of a light beam to pass through for each region,
wherein said polarization direction adjusting means adjust a first polarization direction of a light beam to be emitted passing through a region facing in one diagonal direction, and a second polarization direction of a light beam to be emitted passing through a region facing in the other diagonal direction so as to be mutually orthogonal.

8. The optical pickup device according to claim 7, further comprising:
a polarizer, which is provided between said astigmatism generating means and said photoreception portion, and includes four regions obtained by being divided into two with each of the parting lines formed in said first and second directions, configured to transmit or reflect a light beam to be entered for each region depending on the polarization direction of the light beam;
wherein said polarizer, of light beams to be entered in a region corresponding to a region facing one diagonal direction of said polarization direction adjusting means, reflects a light beam in said first polarization direction, transmits a light beam in said second polarization direction, and of light beams to be entered in a region corresponding to a region facing the other diagonal direction of said polarization direction adjusting means, transmits a light beam in said first polarization direction, and reflects a light beam in said second polarization direction.

9. The optical pickup device according to claim 7, further comprising:
a polarizer, which is provided between said astigmatism generating means and said photoreception portion, and includes four regions obtained by being divided into two with each of the parting lines formed in said first and second directions, configured to transmit or reflect a light beam to be entered for each region depending on the polarization direction of the light beam;
wherein said polarizer transmits a light beam reflected at a recording layer where recording or playback of information is performed, of which the polarization direction is adjusted for each region by said polarization direction adjusting means, and reflects a light beam reflected at another recording layer which is different from said recording layer where recording or playback of information is performed, or the surface, of which the polarization direction is adjusted for each region by said polarization direction adjusting means.

10. An optical pickup configured to subject an optical disc having a single or plurality of recording layers in the incidence direction of a light beam to recording and/or playback of information, comprising:
a light source configured to emit a light beam having a predetermined wavelength;
an objective lens configured to condense the light beam emitted from said light source on a recording layer of an optical disc;
a photodetector including a photoreception portion configured to receive the returned light from said optical disc;
an optical path separating unit, which is disposed between said light source and said objective lens, configured to separate the optical path of the returned light reflected at said optical disc from the optical path of the light beam emitted from said light source;
an astigmatism generating unit, which is provided between said optical path separating unit and said photoreception portion, configured to generate astigmatism regarding a light beam to pass through, to form an image in a first direction at a first position in the optical axis direction, and also to form an image in a second direction generally orthogonal to said first direction at a second position in the optical axis direction which is a position different from said first position; and
an polarization direction adjusting unit, which includes four regions obtained by being divided into two with each of the parting lines formed in said first and second directions, configured to adjust the polarization direction of a light beam to pass through for each region;
wherein said polarization direction adjusting unit adjusts a first polarization direction of a light beam to be emitted passing through a region facing in one diagonal direction, and a second polarization direction of a light beam to be emitted passing through a region facing in the other diagonal direction so as to be mutually orthogonal.

11. An optical disc device comprising:
an optical pickup configured to subject an optical disc having a single or plurality of recording layers in the incidence direction of a light beam to recording and/or playback of information; and
rotational driving means configured to rotate said optical disc;
wherein said optical pickup includes
a light source configured to emit a light beam having a predetermined wavelength,
an objective lens configured to condense the light beam emitted from said light source on a recording layer of an optical disc,
a photodetector including a photoreception portion configured to receive the returned light from said optical disc,
an optical path separating unit, which is disposed between said light source and said objective lens, configured to separate the optical path of the returned light reflected at said optical disc from the optical path of the light beam emitted from said light source;
an astigmatism generating unit, which is provided between said optical path separating unit and said photoreception portion, configured to generate astigmatism regarding a light beam to pass through, to form an image in a first direction at a first position in the optical axis direction, and also to form an image in a second direction generally orthogonal to said first direction at a second position in the optical axis direction which is a position different from said first position; and
an polarization direction adjusting unit, which includes four regions obtained by being divided into two with each of the parting lines formed in said first and second directions, configured to adjust the polarization direction of a light beam to pass through for each region;
wherein said polarization direction adjusting unit adjusts a first polarization direction of a light beam to be emitted passing through a region facing in one diagonal direction, and a second polarization direction of a light beam to be emitted passing through a region facing in the other diagonal direction so as to be mutually orthogonal.
